(19) United States
(12) Patent Application Publication
(10) Pub. No.: US 2018/0214775 A1
(43) Pub. Date: Aug. 2, 2018

(54) INFORMATION PROCESSING DEVICE AND GAME INFORMATION PROCESSING METHOD

(71) Applicant: KABUSHIKI KAISHA SEGA Games doing business as SEGA Games Co., Ltd., Tokyo (JP)

(72) Inventor: Kazutaka Karashima, Tokyo (JP)

(73) Assignee: KABUSHIKI KAISHA SEGA Games doing business as SEGA Games Co., Ltd., Tokyo (JP)

(21) Appl. No.: 15/938,694

(22) Filed: Mar. 28, 2018

Related U.S. Application Data
(63) Continuation of application No. PCT/JP2017/000879, filed on Jan. 12, 2017.

(30) Foreign Application Priority Data
Feb. 4, 2016 (JP) 2016-020152

(51) Int. Cl. A63F 13/63; A63F 13/58; A63F 13/69; A63F 13/47; A63F 13/822; A63F 13/825; A63F 13/335

(52) U.S. Cl. CPC A63F 13/63; A63F 13/58; A63F 13/69; A63F 13/92; A63F 13/822; A63F 13/825; A63F 13/335; A63F 13/47

(57) ABSTRACT

An information processing device is disclosed including a receiver that receives an input operation from the user. The information processing device includes a memory that stores a plurality of attribute values of one or more characters of a game determined based on the input operation. The plurality of attribute values comprise a first attribute value of a first character. The information processing device includes a processor connected to the receiver and the memory and that controls progress of the game based on the plurality of attribute values. The processor changes the first attribute value, when a fusion instruction for a second character that is correlated with the first character is detected. The processor changes the first attribute value, when a cost associated with at least an elapsed time is spent. The processor changes the cost when a fusion instruction is detected. The processor outputs, to the memory, the changed first attribute value and the changed cost.

### TECHNICAL FIELD

The present invention generally relates to a control method for evolving characters in a computer game.

### RELATED ART

There are games in which players gather various characters and pit their own characters against opposing teams. Characters can be acquired by lottery or by play results. Characters can have a wide range of abilities, with some characters being easy to acquire and some being more difficult (hereinafter referred to as a “rare characters”).

One common method for acquiring a strong character is to introduce the game concept of “evolution.” As an example, there is an evolution method in which when two characters A are combined, one character A disappears and the attribute value of the other character A is increased (see Patent Literature 1). Such evolution will be called “fusion evolution” herein.

Patent Literature 1: JP-A 2014-131758

Fusion evolution has the advantage that stronger characters can be created by combining the characters, so the acquisition of duplicate characters does not end up being a waste. However, in the case of rare characters, since it is difficult for the player to get the same rare characters in duplicate, it is hard to provide opportunities for fusion evolution.

### SUMMARY

One or more embodiments of the present invention provide a way to afford greater strategy to the evolution of game characters.

One or more embodiments of the present invention provide a game execution component that controls the progress of the game by referring to the attribute values of characters, a first evolution component that changes the attribute value of a first character favorably for a player, on the condition that a fusion instruction for a second character that is correlated with the first character has been detected for the first character, a second evolution component that changes the attribute value of the first character favorably for the player, on the condition that the cost associated with at least the elapsed time has been spent, and a cost setting component that changes the cost in the second evolution component, on the condition that a fusion instruction by the first evolution component has been detected.

One or more embodiments of the present invention provide an information processing device that includes a receiver that receives an input operation from a user, a memory that stores a plurality of attribute values of one or more characters of a game determined based on the input operation, and a processor connected to the receiver and the memory. The plurality of attribute values include a first attribute value of a first character. The processor controls progress of the game based on the plurality of attribute values. The processor detects a fusion instruction for a second character that is correlated with the first character. The processor changes, with a first evolution component, the first attribute value based on the fusion instruction. The processor changes, with a second evolution component, the first attribute value, when a cost associated with an elapsed time has been spent. The processor changes the cost based on the fusion instruction. The processor outputs, to the memory, the first attribute value changed with the first evolution component, the first attribute value changed with the second evolution component, and the changed cost. One or more embodiments of the present invention provide an information processing device that includes a receiver that receives an input operation from a user, a memory that stores a plurality of attribute values of one or more characters of a game determined based on the input operation, a processor connected to the receiver and the memory. The plurality of attribute values include a first attribute value of a first character. The processor controls a progress of the game based on the plurality of attribute values, detects a fusion instruction of a second character that is correlated with the first character, changes, with a first evolution component, the first attribute value designated for evolution to a first predetermined attribute value with a first probability based on the fusion instruction, changes, with a second evolution component, the first attribute value to a second predetermined attribute value with a second probability that is higher than the first probability when a specific amount of cost associated with an elapsed time has been spent for the first character, changes the cost based on the fusion instruction, and outputs, to the memory, the first attribute value changed with the first evolution component, the first attribute value changed with the second evolution component, and the changed cost.

One or more embodiments of the present invention provide a game information processing method that causes a computer to execute a game program. The method includes receiving, with a receiver, an input operation from a user, storing, with a memory, an attribute value of a first character of a game based on the input operation, detecting, with a processor, a fusion instruction of a second character is correlated with the first character, changing, with the processor, the attribute value of a first character based on the fusion instruction, changing, with the processor, the attribute value when a cost associated with at least an elapsed time has been spent, changing with the processor, the cost based on the fusion instruction, outputting, to the memory, the changed attribute value and the changed cost, and controlling, with the processor, a progress of the game based on the changed attribute value.

One or more embodiments of the present invention enhance the strategy of a game by leaving it up to the player to select how game characters will evolve.

### BRIEF DESCRIPTION OF DRAWINGS

FIG. 1 is a hardware configuration diagram of a game system according to one or more embodiments of the present invention.

FIG. 2 is a functional block diagram of a game system according to one or more embodiments of the present invention.

FIG. 3 is a simplified diagram of game character graphics and the skills thereof according to one or more embodiments of the present invention.

FIG. 4 is a simplified diagram showing the relation between an execution character and an extra character according to one or more embodiments of the present invention.

FIG. 5 is a flowchart showing the steps of processing in evolution over time according to one or more embodiments of the present invention.

FIG. 6 is a flowchart showing the steps of processing in fusion evolution according to one or more embodiments of the present invention.

### DETAILED DESCRIPTION

If the character evolution method is limited to fusion evolution, the evolution of the character substantially ends when fusion evolution becomes difficult to achieve.. The game system 100 in accordance with one or more embodiments of the present invention provides two different evolution methods. Game strategy is enhanced by allowing the player to select between these two evolution methods, as dictated by the game situation.

In one or more embodiments, two types of evolution are proposed: “fusion evolution” and “evolution over time.” Each type of evolution will be summarized below, after which the specific configuration and control method of the game system 100 will be described. The term “character” is not limited to so-called game characters such as those in human or demon form, and also encompasses weapons, armor, and other such game items that a player can use and that are tied to growable parameters.

(1) Fusion Evolution

This is evolution in which the attribute value of a base character A (first attribute value) changes favorably for the player by combining the character A that is the base (the one that will evolve) and a character B that is the raw material (the one that is sacrificed). For example, the attribute value is changed to a first predetermined attribute value with a first probability so the attribute value is changed favorably for the player. “Changes favorably for the player” means that the character A becomes more powerful, or that the progress of the game becomes easier as the character A acquires new abilities, for instance. In one or more embodiments, the success rate of fusion evolution (probability) is set to be less than 95%.

The combination of the base character with the character serving as the raw material may be initially set as desired, but one or more embodiments are described on the assumption that fusion evolution is possible through the combination of characters of the same type. Also, in one or more embodiments, the raw material character disappears regardless of the success or failure of the fusion evolution.

Fusion evolution can be executed immediately as long as the player has two characters of the same type. Accordingly, if the player is lucky, he can strengthen his team in a short time. On the other hand, since it is difficult to get two rare characters of the same type, it is hard to evolve a rare character. Also, since the success rate is set for fusion evolution, the risk of losing a character that could serve as raw material if it fails might cause the player to hesitate.

(2) Evolution Over Time

This is evolution in which the attribute value of the character changes favorably for the player when a character is set to be one that evolves. For example, the attribute value is changed to a second predetermined attribute value with a second probability so the attribute value is changed favorably for the player. Evolution over time is costly. More specifically, its costs are resources and time. A resource is something that can promote evolution (a part of the game content), and is acquirable when an event that comes up during a game has been cleared, or when game points or the like are consumed or time elapses under a predetermined game situation (for example, when the player virtually owns a field (land) of level 1, a certain amount of “wheat (resource)” is awarded to the player in one hour; if the level of the land increases, the amount of resource that is obtained each hour will increase). Time is the time elapsed since the character was set for evolution. When a predetermined amount of resources is invested and a predetermined length of time elapses, the character evolves over time. The cost may be either in resources or time, or both, but in one or more embodiments, the description will focus on time. Also, in one or more embodiments, it is assumed that the success rate of evolution over time (probability) is between 95 and 100%. At the very least, the success rate of evolution over time is initially set so as to be higher than the success rate of fusion evolution.

The evolution over time will take longer the more the character attribute value increases. In other words, the more a character evolves, the more it will cost for it to evolve further. For example, it may take only 30 minutes (0.5 hour) for an attribute value to evolve from level 1 to level 2, whereas one day (24 hours) may be set as the time for evolution over time from level 10 to level 11. This time can also be shortened by consumption of game contents owned by the player (game points, game items, characters, etc.). These game contents are awarded according to general game conditions, such as clearing a battle stage, play during an event period, and gifts from friendly players.

In the evolution over time in accordance with one or more embodiments, it is highly likely that a character can be evolved as long as time (cost) is spent, so one game benefit is that steady, consistent play will be rewarded. On the other hand, players who have been playing for a long time tend to have an advantage, so playing time tends to make a difference.

In one or more embodiments, the strategy of the game is enhanced by combining fusion evolution, in which the probability of success is low but the level can be increased all at once, and evolution over time, which is more costly but allows the level to steadily increase. When fusion evolution and evolution over time are each executed for the same character, a given attribute value changes in a given manner (that is, the results upon success should be the same regardless of which evolution the player selects), but it is not limited to this. Different attribute values may change between fusion evolution and evolution over time, or the amount of change may be different for the same attribute value.

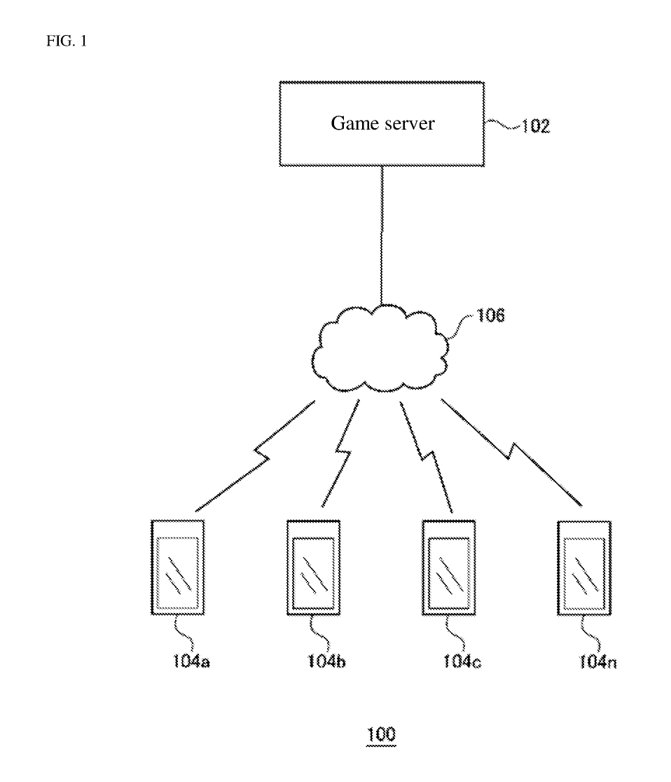

FIG. 1 is a hardware configuration diagram of the game system 100. In the game system 100, a game server 102 is connected via the Internet 106 to a plurality of game terminals 104a, 104b, 104c, . . . , 104n (hereinafter, when referred to collectively, these will be called the “game terminals 104” without distinguishing between them). The game terminals 104 in one or more embodiments are assumed to be smart phones. The game terminals 104 may be a portable dedicated game machine, or may be a general-purpose computer such as a laptop PC. The game terminals 104 and the Internet 106 are connected wirelessly, but may instead be connected by wire. A unique ID called a player ID is assigned ahead of time to the player of the game. The game server 102 provides the game to each of the game terminals 104.

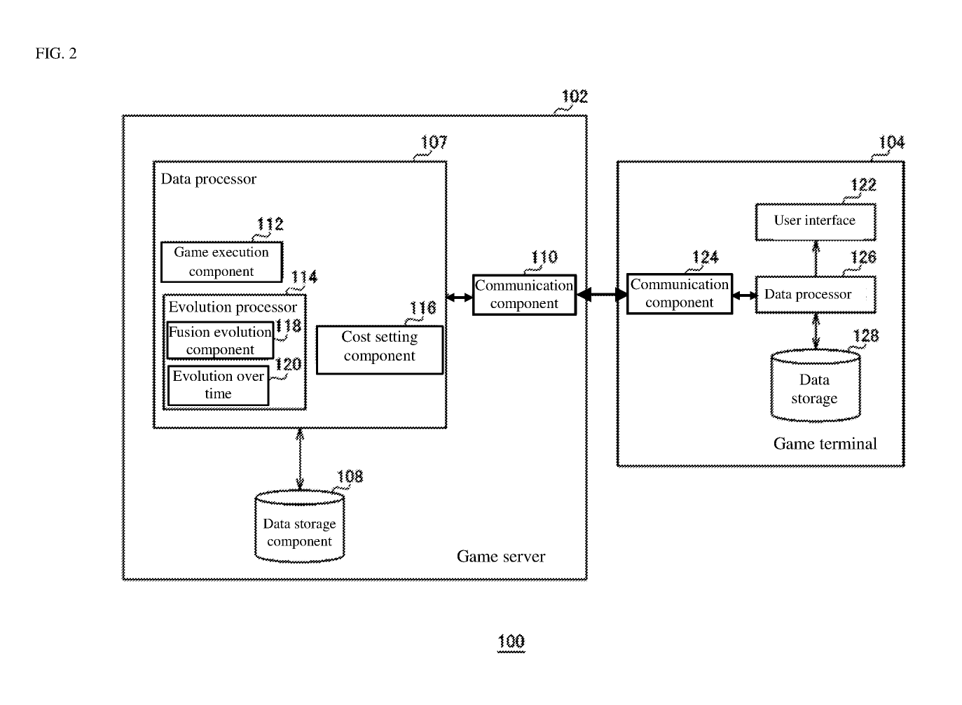

FIG. 2 is a functional block diagram of the game system 100. As described above, the game system 100 includes the game server 102 and the game terminals 104. The constituent elements of the game terminals 104 and the game server 102 are made up of hardware such as a CPU (central processing unit), a computing device such as various co-processors, a storage device such as a memory or storage, and a wired or wireless communication line connecting these, and software that is stored in the storage device and supplies processing commands to the computing device. The computer program may be constituted by a device driver, an operating system, various application programs located in upper layers thereof, and a library that provides shared functions to these programs. The blocks described below are not configured in hardware units, but are functional unit blocks.

The game server 102 may have a configuration that includes a web server, or the game terminals 104 may include a portable communication terminal and a web browser installed therein.

The game server 102 includes a communication component 110, a data processor 107, and a data storage component 108. The communication component 110 handles communication processing with the game terminals 104 via the Internet 106. The data storage component 108 stores various kinds of data. The data processor 107 executes various kinds of processing based on the data acquired by the communication component 110 and the data stored in the data storage component 108. The data processor 107 also functions as an interface to the communication component 110 and the data storage component 108. In addition to the game program, the data storage component 108 manages the players with player IDs, and stores information indicating the play state of the players. For example, information about which characters each player owns is also stored in the data storage component 108 as play state information.

The data processor 107 includes a game execution component 112, an evolution processor 114, and a cost setting component 116. The game execution component 112 controls the progress of the game. The game execution component 112 makes a win or loss determination when playing against an enemy character according to the attribute value (ability) of the characters owned by the players (more precisely, the execution characters, which will be described in detail below). It is also the game execution component 112 that determines whether or not characters and items will be awarded by lottery. The evolution processor 114 controls the evolution of characters. The evolution processor 114 includes a fusion evolution component (first evolution component) 118 that controls fusion evolution and an evolution over time component (second evolution component) 120 that controls evolution over time. The cost setting component 116 sets the cost required for evolution over time.

The game terminals 104 each include a user interface 122, a communication component 124, a data processor 126, and a data storage component 128. In addition to accepting operations from the player, the user interface 122 handles processing such as image display and audio output. The communication component 124 handles processing for communication with the game server 102 and other game terminals 104 via the Internet 106. The data storage component 128 stores various kinds of data. The data processor 126 executes various kinds of processing based on the data acquired by the user interface 122 and the communication component 124 and the data stored in the data storage component 128. The data processor 126 also functions as an interface to the user interface 122, the communication component 124, and the data storage component 128.

The communication component 124 acquires various kinds of game information from the game server 102, and the data processor 126 displays a game screen on the user interface 122. The user interface 122 also detects various inputs made by the player, and the data processor 126 sends the game server 102 the inputted information via the communication component 124. The data processor 107, and particularly the game execution component 112, controls the progress of the game according to this inputted information.

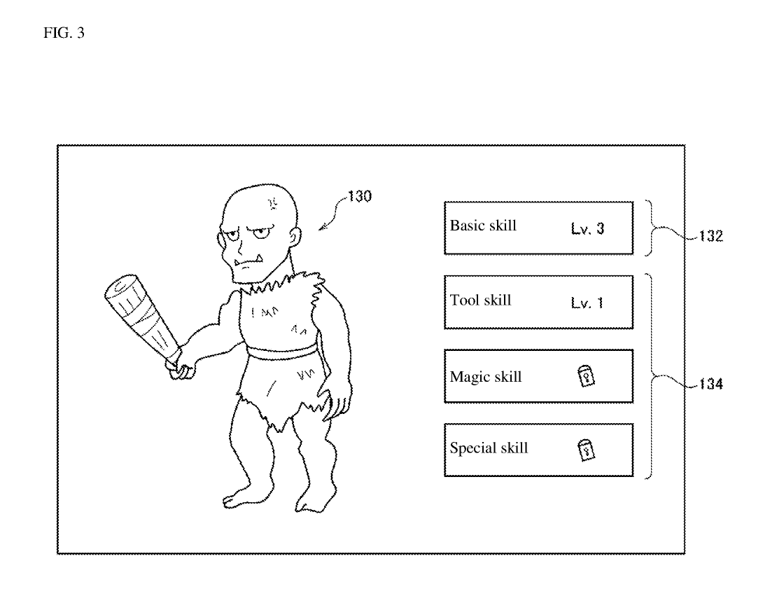

FIG. 3 is a simplified diagram illustrating game characters and skills. In the game, a plurality of characters appear. FIG. 3 shows a graphic of a character 130 (a character owned by the player) and its skills. The user interface 122 displays the screen shown in FIG. 3. The character 130 has one basic skill 132 and three different optional skills 134. The basic skill 132 indicates the basic attack power and hit point level. The three optional skills 134 consist of a tool skill, which is a skill at using weapons or armor, a magic skill, which is the ability to use magic, and a special skill, which is something that only the character 130 can do.

The game executing component 112 judges superiority and inferiority based on the difference between or combination of the skills (attribute values) of the character presented by the player and the skills (attribute values) of the enemy character, and decides whether a character wins or loses while taking randomness based on this superiority or inferiority into consideration. Deciding whether the character wins or loses can be accomplished by the application of existing technology.

Levels are set for each skill. The more the level increases, or in other words, the more the attribute values change favorably for the player, the stronger the character 130 becomes. In the initial state, the level of the basic skill 132 is set to 1, and the three optional skills 134 are all locked.

In fusion evolution or evolution over time, the player designates either the basic skill 132 or the unlocked optional skills 134 as what is to evolve. When the basic skill 132 of level 1 is designated and the evolution is successful, the level of the basic skill 132 is increased from 1 to 2. When the level of the basic skill 132 goes from 2 to 3, the tool skill is unlocked. Similarly, when the level of the basic skill 132 reaches 5, the magic skill is unlocked, and when the level of the basic skill 132 reaches 10, the special skill is unlocked.

In evolution, the player fosters the character 130 while increasing the level of the basic skill 132 and at the same time deciding whether to prioritize the unlocking of optional skills 134 or to prioritize increasing the level of the already-unlocked optional skills 134. In other words, the player not only selects between fusion evolution and evolution over time, but also selects whether the basic skill 132 or the optional skills 134 will be what evolves, which boosts the strategy of the game.

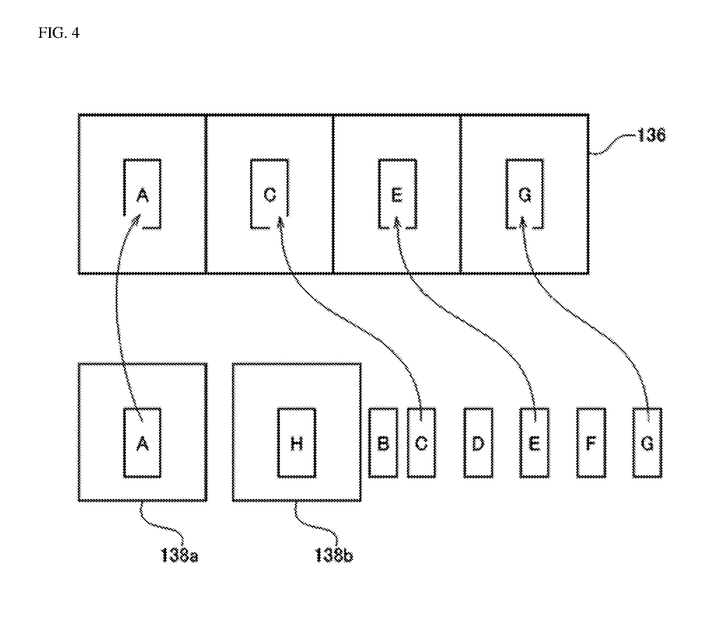

FIG. 4 is a simplified diagram showing the relation between execution characters and extra characters. The player collects characters by lottery. When a certain event condition such as game point consumption or victory in a battle is met, the player is awarded a drawing for character acquisition. In a game, characters may be designed as cards, figures, or the like. A character may be given as a gift by another player, or may be awarded for playing during an event period set by the game execution component 112, or may be provided on the condition of clearing a game stage set by the game execution component 112.

A player classifies a character as either an execution character or an extra character. An execution character is a regular member who fights against the enemy team, and extra characters are reserve members. The player puts his execution characters in the four regular frames 136 set by the game execution component 112. More specifically, the player selects up to four execution characters from among his characters displayed on the screen of the game terminal 104, and the game execution component 112 recognizes those execution characters. The execution characters are placed in the regular frames 136.

In FIG. 4, of the eight characters A to G, characters A, C, E, and G are execution characters, and the rest are extra characters.

Furthermore, the game execution component 112 readies a finite number of character storage areas 138a and 138b (two, in one or more embodiments described below). Characters placed in the character storage areas 138 will be subject to evolution over time. Hereinafter, the characters placed in the character storage areas 138 will be referred to as “evolution over time characters.” The player places (instructs to start the time) his characters in each of the two character storage areas 138 configured by the game execution component 112. More specifically, the player selects up to two of his characters displayed on the screen of the game terminal 104, and the game execution component 112 recognizes the characters to be placed in the character areas 138.

Characters placed in the character areas 138 begin their evolution over time. How long the evolution takes is predetermined according to the level; for example, it may take 30 minutes for the basic skill 132 of the character 130 to change from 1 to 2, and 1 hour for a change from 2 to 3. The same applies to the optional skills 134, and the time required for evolution is defined according to the character, the skill, and the level. In one or more embodiments, the higher the level of the character, the longer it takes for the character to evolve, or in other words, the harder it is to increase the level.

It is also possible to set an evolution over time character to be an execution character. Since characters can be used in battle while in the midst of evolution over time, selection of an execution character is not restricted in order to prioritize evolution over time.

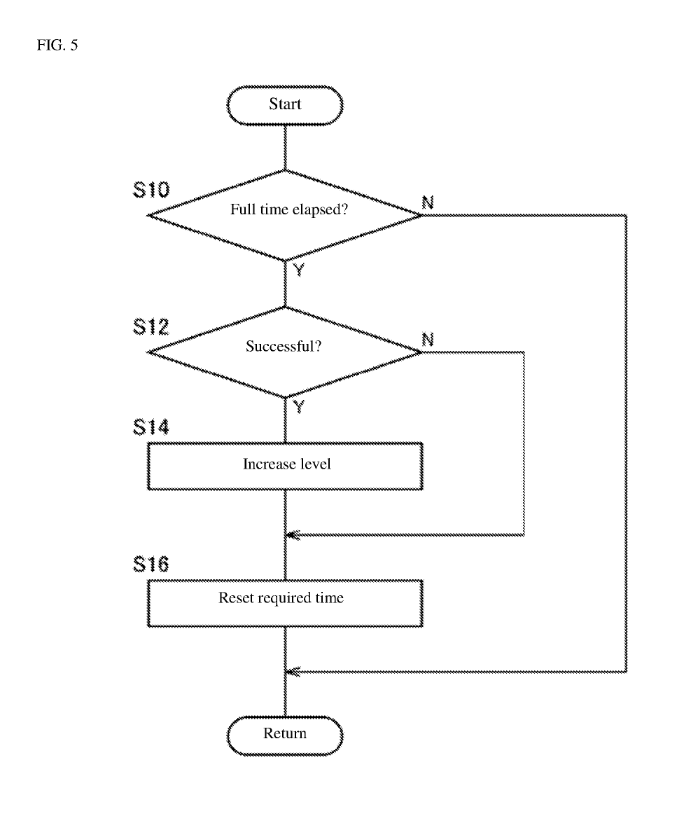

FIG. 5 is a flowchart showing the steps of processing in evolution over time. When a character is placed in a character storage area 138, the player specifies the skill that will evolve. For example, when the basic skill 132 is specified, the cost setting component 116 sets a predetermined time according to the current level of the character, or according to the next level. The elapsed time since the character was placed in the character storage area 138 is measured by an evolution over time component 120 with a timer.

If the full time has not elapsed (No in S10), the processing from S12 on are not executed. If the full time has elapsed (Yes in S10), the evolution over time component 120 determines whether the evolution over time was a success or failure based on the success rate of evolution over time (probability). If it is a success (Yes in S12), the target skill level is raised (S14). If it is a failure (No in S12), the level is not raised. As in one or more embodiments, when the success rate of evolution over time is set to 100%, the level is always raised once the full time has elapsed.

After this, the cost setting component 116 sets the time necessary for further evolution (S16). For example, when the basic skill 132 has evolved from level 1 to level 2 over time, a longer time period is set corresponding to the new level 2 or the next level 3. As long as there is a character in the character storage area 138, the time for evolution over time continues to elapse.

The player can shorten the time as needed by consuming game contents. The player acquires game contents during the game and designates the characters and skills to be used for the game contents. For example, let us assume that a game content was used when the time for evolving the tool skill of the character 130 was 5 hours and the elapsed time thereof was 20 minutes (remaining time is 4 hours and 40 minutes). In this case, the time may be shortened by a predetermined amount, such as one hour, for each game content so that the time required for evolution is reduced from 5 hours to 4 hours. As a result, the remaining time is also shortened to 3 hours and 40 minutes, so evolution over time is promoted. This affords the strategy of promoting evolution over time using game contents while waiting for completion of evolution over time. Also, the evolution over time may be completed instantly through the consumption of game contents according to the remaining time, or the remaining time may be shortened through the consumption of game contents.

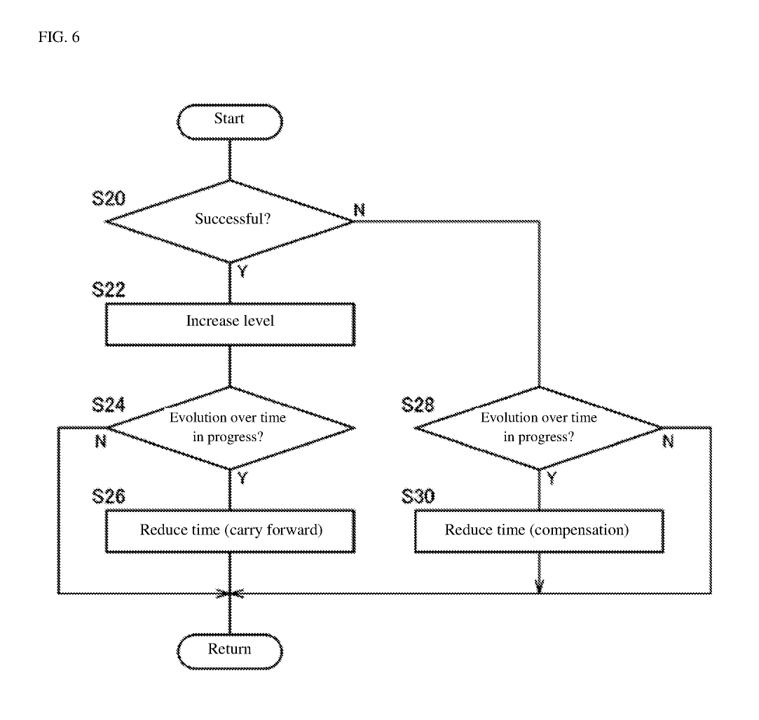

FIG. 6 is a flowchart showing the steps of processing in fusion evolution. When a player acquires two of the same character, the fusion evolution can be executed once the base character and the raw material character have been specified. Again in fusion evolution, the skills to evolve are specified. The fusion evolution component 118 determines success or failure of fusion evolution from a predetermined fusion success rate (probability). If it is a success (Yes in S20), the target skill level is raised (S22). If the raw material character is an evolution over time character (Yes in S24), the cost setting component 116 decreases the time for further raising the level of the character from the initial setting (S26).

For example, let us assume that the magic skill of the character 130 is in the midst of evolution over time, from level 2 to level 3. Let us also assume that the time required for this evolution is 6 hours, and the elapsed time (invested cost) is 2 hours (remaining time is 4 hours). In this state, let us assume that the fusion evolution is successful and the magic skill of the character 130 has evolved to level 3. The initial setting of the time for evolving the magic skill of the character 130 from level 3 to level 4 is 8 hours. At this point, the elapsed time of 2 hours does not become a sunk cost, but it is carried forward to the evolution over time from level 3 to level 4. More specifically, the time required for evolution over time from level 3 to level 4 is changed from 8 hours to 6 hours (=8−2). If evolution over time is not in progress (No in S24), S26 is skipped.

Even if the fusion evolution has failed (No in S20), and if the base character is an evolution over time character (Yes in S28), the cost setting component 116 decreases the time required for evolution over time to be less than the initial setting (S30). Let us assume that fusion evolution has failed while the magic skill of the character 130 is in the midst of evolution over time, from level 2 to level 3. In this case, the cost setting component 116 changes the time required for evolution over time from 6 hours to 4 hours (=6−4/2) so that the remaining time of 4 hours is halved. Failure at fusion evolution results in sustaining a loss of the raw material character, but this is compensated for by a reduction in the time required for evolution over time. If evolution over time is not in progress (No in S28), S30 is skipped.

The game system 100 was described above on the basis of one or more embodiments. According to one or more embodiments, when fusion evolution of an evolution over time character succeeds, the cost of the elapsed time that has been invested up to that point is carried forward for the next evolution over time. Therefore, even during evolution over time, if an opportunity to try for fusion evolution should arise, an incentive can be given to go ahead and aim for fusion evolution. Also, even if the fusion evolution of an evolution over time character fails, a sort of loss compensation of shortening the time required for evolution over time can be received, so this is also an incentive to execute fusion evolution. With a control method such as this, a player who likes steady evolution (evolution over time) can be easily guided toward fusion evolution, which is set to have a higher probability of failure. As a result, a player can not only make use of evolution over time, but can also choose between fusion evolution and evolution over time depending on the game situation, which means that the inherent features of the game can be manifested more effectively.

Fusion evolution requires the player to get two of the same characters, but in the case of a rare character, it is conceivable that the player will never get the chance to use fusion evolution. In the case of rare characters that are provided only during a marketing period, it is extremely difficult to acquire two or more such rare characters for use in fusion evolution. For this reason, in the past, players would often give up on fusion evolution of a rare character from the outset. In one or more embodiments, even with a rare character, evolution over time can still be performed, so a player can enjoy leisurely raising a rare character.

The present invention is not limited to or by the above one or more embodiments and modification examples, and can be embodied by modifying the constituent elements without departing from the gist of the invention. Various inventions may be formed by appropriately combining a plurality of the constituent elements disclosed in the above one or more embodiments and modification examples. Also, some of the constituent elements may be omitted from among all the constituent elements in the above one or more embodiments and modification examples.

While the game system 100 was described as being made up of a plurality of the game terminals 104 and one game server 102, some of the functions of the game terminals 104 may be realized instead by the game server 102, or some of the functions of the game server 102 may be assigned to the game terminals 104. Also, a third device other than the game terminals 104 and the game server 102 may handle some of the functions. A collection of the functions of the game terminals 104 and the functions of the 102 as illustrated in FIG. 2 may also be thought of broadly as a single “information processing device (game device).” How the functions required for one or more embodiments of the present invention are distributed to one or more pieces of hardware may be decided in consideration of the specifications required of the game system 100 and the processing performance of each piece of hardware.

In one or more embodiments, when an evolution over time character is subjected to fusion evolution, the elapsed time (invested cost) up to that point was carried forward for the next evolution over time according to the success or failure of the fusion evolution, or the time required for evolution over time was shortened according to the elapsed time, but a bonus or compensation may be provided for characters which are not in the midst of evolution over time. For example, when fusion evolution of a non-evolution over time character is successful, the cost setting component 116 may halve the time required for evolution over time, and when fusion evolution of a non-evolution over time character is a failure, the cost setting component 116 may reduce the time required for evolution over time to ¾. More specifically, let us assume that the time required for evolution over time from magic level 2 to 3 is 6 hours, and the time required for evolution over time from 3 to 4 is 8 hours. When fusion evolution from magic level 2 to 3 is successful, the time required for the next evolution over time from magic level 3 to 4 is halved from 8 hours to 4 hours. On the other hand, when fusion evolution from magic level 2 to 3 fails, the time required for evolution over time from magic level 2 to 3 may be reduced to 4.5 hours, which is ¾ of 6 hours. Also, in one or more embodiments, the time required for the next evolution over time was shortened directly, but the time may be indirectly shortened by distributing the above-mentioned game contents to the players. For example, instead of shortening the time required for evolution over time from magic level 2 to 3 from 6 hours to 4.5 hours (¾ of 6 hours), game contents that allow the time to be shortened by 1.5 hours can be distributed. At this point, characters that can use the distributed game contents may be restricted to characters which are in the midst of evolution over time, or this may be used for characters which are not in the midst of evolution over time.

When fusion evolution fails, a penalty may be given rather than a bonus. In the example described above, when fusion evolution from magic level 2 to 3 was successful, the time required for the next evolution over time from magic level 3 to 4 is halved from 8 hours to 4 hours, but when fusion evolution from magic level 2 to 3 fails, the time required for evolution over time from magic level 2 to 3 may be extended from 6 hours to 9 hours, which is 1.5 times 6 hours. With a control method such as this, the benefits and drawbacks to success and failure at fusion evolution become clearer, so this leads to greater anticipation and greater disappointment associated with fusion evolution.

When fusion evolution is successful, the time required for evolution over time may not be reduced that much, and when fusion evolution fails, the time required for evolution over time may be greatly reduced. For example, when fusion evolution is successful, the cost setting component 116 may reduce the time required for evolution over time by 10%, and when fusion evolution fails, it may cut the time required for evolution over time in half. With this control method, there is a large bonus when fusion evolution fails, so this encourages the player to give fusion evolution a try.

One basic strategy that is possible is to allow a character that is to be evolved to undergo evolution over time, and if there is an opportunity for fusion evolution, to give it a try after taking into account the risk and reward. To take this a step further, there is a strategy in which the player already has two of the same character A, and allows one character A to undergo evolution over time while waiting for just the right time to subject both characters to fusion evolution (hereinafter referred to as a “wait-and-see strategy”).

A wait-and-see strategy may be prohibited. For example, the game execution component 112 records the time of day when a character was acquired. The evolution over time component 120 may control so that evolution over time is not possible even though the player has two of the same characters and evolution over time was started for one of the characters. Alternatively, in such a case, the evolution over time component 120 may disable the wait-and-see strategy by greatly reducing the success rate of evolution over time or setting it to 0%. The evolution over time component 120 in the above situation may decrease the incentive to employ a fusion wait-and-see strategy by reducing the reward, bonus, and carryover associated with fusion evolution.

In one or more embodiments, the time required for evolution over time was described as a cost of evolution over time, but as mentioned at the beginning, cost may be an item or other such resource. For example, evolution over time may be performed on the condition that a predetermined amount of virtual points are accumulated in the game world. For example, the number of virtual points required may be set to be larger the more the attribute value of a character is increased, for example, 1000 virtual may be required for evolution over time from the basic level 1 to 2, but 1500 virtual points are required for evolution over time from 2 to 3.

Virtual points may be increased 1% per hour. A setting such as this allows a time element to be imparted to the resource of virtual points.

Depending on the success or failure of fusion evolution, instead of increasing or decreasing the cost entailed by evolution over time, namely, the time or game contents required for evolution over time, the success rate of fusion evolution or evolution over time may be increased or decreased. For example, the setting may be such that the more successful is the fusion evolution, the higher is the success rate of the next fusion evolution. Alternatively, the setting may be such that the more successful is the fusion evolution, the higher is the percentage decrease in the time required for evolution over time. If the setting is such that the more successful is the fusion evolution, the easier it is to acquire the desired character by lottery, and the higher is the success rate of fusion evolution, then it will be possible to create a temporary game state that is extremely advantageous to the player.

The cost entailed by evolution over time, the success rate of fusion evolution and evolution over time, the difficulty of acquiring each character, and the number of characters in the character storage areas 138 all affect the game balance. The balance between losses and gains may be adjusted by raising the probability of acquiring a rare character by lottery when a player fails at fusion evolution. If the setting is such that rare characters are relatively easy to obtain but their fusion evolution is less likely to succeed, rather than making rare characters very hard to obtain and thereby limiting opportunities for fusion evolution, a good overall game balance can be maintained, while affording more opportunities to attempt fusion evolution.

In one or more embodiments, the elapsed time (cost) is increased or decreased according to the attribute value associated with a character, but an attribute value such as efficiency may be assigned to the character storage areas 138, rather than to characters. For example, the cost setting component 116 may subsequently adjust so that the elapsed time is shorter the higher is the efficiency value of a character storage area 138. When an evolution over time character is then subjected to fusion evolution, the cost setting component 116 may increase or decrease the efficiency value of the character storage area 138 according to the success or failure of the fusion evolution.

If the raw material character is also an evolution over time character, and not just the base character, the elapsed time of the character serving as the raw material may be added to the elapsed time of the character serving as the base, and carryover or compensation may be performed on the basis of this sum according to the success or failure of the fusion evolution. Alternatively, when two evolution over time characters are combined and subjected to fusion evolution, the fusion evolution component 118 may execute fusion evolution at a higher success rate than normal.

In one or more embodiments, a case in which the attribute values of characters increased through evolution was described, but the type of character itself may also change. For example, a stronger character B may be created through fusion evolution or evolution over time from the character A. Also, the evolution processor 114 may prohibit processing that evolves the character A into the character B in a state in which the player already has the character B, and performs fusion evolution on a character B that has been obtained by evolution with a character B that was owned from the outset. For instance, in a state in which the player has a character B, evolution from the character A to the character B may be prohibited.

In one or more embodiments, it was described that fusion evolution is possible by combining two characters of the same type, but they do not necessarily have to be the same type. For example, the configuration may allow fusion evolution even if the characters are not the same (such as a troll and a dwarf), as long as the combination belongs to the same family of “little people.” The combinations for which fusion evolution is thus possible may have their correlation defined in advance. Also, the number of characters is not limited to two, and three or more may also be subjected to fusion evolution together.

Although the raw material character disappears after fusion evolution, after the disappearance, it may change to a resource, or it may change to some other game content (a weak character, etc.).

Although the disclosure has been described with respect to only a limited number of embodiments, those skilled in the art, having benefit of this disclosure, will appreciate that various other embodiments may be devised without departing from the scope of the present invention. Accordingly, the scope of the invention should be limited only by the attached claims.
100 game system
102 game server
104 game terminal
106 Internet
107 data processor
108 data storage component
110 communication component
112 game execution component
114 evolution processor
116 cost setting component
118 fusion evolution component
120 evolution over time component
122 user interface
124 communication component
126 data processor
128 data storage component
130 character
132 basic skill
134 optional skill
136 regular frame
138 character storage area

What is claimed is:

1. An information processing device, comprising:
a receiver that receives an input operation from a user;
a memory that stores a plurality of attribute values of one or more characters of a game determined based on the input operation, wherein the plurality of attribute values comprise a first attribute value of a first character; and
a processor connected to the receiver and the memory and that:
controls progress of the game based on the plurality of attribute values;
detects a fusion instruction for a second character that is correlated with the first character;
changes, with a first evolution component, the first attribute value based on the fusion instruction;
changes, with a second evolution component, the first attribute value, when a cost associated with an elapsed time has been spent;
changes the cost based on the fusion instruction; and
outputs, to the memory, the first attribute value changed with the first evolution component, the first attribute value changed with the second evolution component, and the changed cost.

2. The information processing device according to claim 1, wherein the processor:
sets, with the second evolution component, a third character to a second evolution state when an evolution start instruction for the third character is detected,
classifies the third character as either an execution character or an additional character according to an instruction from a user, and
controls the progress based on the attribute value of the execution character.

3. The information processing device according to claim 1,
wherein the processor changes, with the first evolution component, the first attribute value to a first predetermined attribute value with a first probability,
wherein the processor changes, with the second evolution component, the first attribute value to a second predetermined attribute value with a second probability, and
wherein the first probability is lower than the second probability.

4. The information processing device according to claim 1,
wherein the processor changes, with the first evolution component, the first attribute value to a first predetermined attribute value with a first probability, and
wherein the processor reduces the cost when the processor does not change the first attribute value to the first predetermined attribute value.

5. The information processing device according to claim 1,
wherein the processor changes, with the first evolution component, the first attribute value to a first predetermined attribute value with a first probability, and
wherein the processor reduces the cost when the processor changes the first attribute value to the first predetermined attribute value.

6. The information processing device according to claim 5,
wherein the processor changes the first attribute value to the first predetermined attribute value when part of the cost required for evolution of the first character has been spent, and
wherein the processor reduces a remaining portion of the cost required for the evolution.

7. An information processing device, comprising:
a receiver that receives an input operation from a user;
a memory that stores a plurality of attribute values of one or more characters of a game determined based on the input operation, wherein the plurality of attribute values comprise a first attribute value of a first character; and
a processor connected to the receiver and the memory and that:
controls a progress of the game based on the plurality of attribute values,
detects a fusion instruction of a second character that is correlated with the first character,
changes, with a first evolution component, the first attribute value designated for evolution to a first predetermined attribute value with a first probability based on the fusion instruction,
changes, with a second evolution component, the first attribute value to a second predetermined attribute value with a second probability that is higher than the first probability when a specific amount of cost associated with an elapsed time has been spent for the first character,
changes the cost based on the fusion instruction, and
outputs, to the memory, the first attribute value changed with the first evolution component, the first attribute value changed with the second evolution component, and the changed cost.

8. A game information processing method that causes a computer to execute a game program, the method comprising:
receiving, with a receiver, an input operation from a user;
storing, with a memory, an attribute value of a first character of a game based on the input operation;
detecting, with a processor, a fusion instruction of a second character is correlated with the first character;
changing, with the processor, the attribute value of a first character based on the fusion instruction;
changing, with the processor, the attribute value when a cost associated with at least an elapsed time has been spent;
changing with the processor, the cost based on the fusion instruction; and
outputting, to the memory, the changed attribute value and the changed cost,
controlling, with the processor, a progress of the game based on the changed attribute value.
